(19) United States
(12) Patent Application Publication
(10) Pub. No.: US 2003/0234531 A1
(43) Pub. Date: Dec. 25, 2003

(54) Stretchable fabric book cover and method

(76) Inventor: Robert S. Silverman, Long Beach, CA (US)

Correspondence Address: Douglas W. Eggins, 18 Downsview Drive, Barrie, ON, L4M 4P8, CA

(21) Appl. No.: 10/177,964

(22) Filed: Jun. 24, 2002

(51) Int. Cl. B42D 3/00

(52) U.S. Cl. 281/29

(57) ABSTRACT

A flexible, preferably elastic empanelled book cover has pocket portions to receive the covers of a book in inserted relation therein. The cover consists of a unitary hexagonal sheet of pliable material such as spandex, with extended upper and lower edges, each bisected by a slot of predetermined depth extending orthogonally. Fold lines that form a laterally extended rectangle include side fold lines forming with the lateral apices of the hexagon two triangular flap portions of the cover pockets. The in-folded upper and lower flap portions of the hexagon are attached to each other and to the triangular side flap portions, to form the pocket portions, with lockstitiching at the innermost juncture by the spine opening. A central top and bottom fold-over engages the spine of the book in stabilizing relation. The unitary hexagonal blanks can be economically mass produced from roll material.

### BACKGROUND OF THE INVENTION

This invention relates to adjustable book covers, and more particularly to a protective elastic fabric covering which easily conforms to a variety of book sizes. Specifically, the invention features an improved construction, and a method for fabricating an adjustable fabric sleeve that snugly envelops the exterior paperboard panels and spine of a book.

Numerous book covers have been devised to protect schoolbooks and other hard covered texts from moisture or grime. Many of these coverings utilize Kraft paper wrappings or have been fabricated from more durable plastic materials. The application of such book jackets require the time consuming steps of trimming the covering to size, fashioning and folding flaps, then inserting the front and back panels of a bound book into lateral envelopes formed by the flaps. Adhesive tape may also be required to secure the protective covering into position which typically will mar a text when removed. Some conventional plastic book covers are similarly available with a coating of repositionable pressure sensitive adhesive. Although intended to removably cling to the exposed surfaces of a book, such coverings are known to become troublesome to remove after long term usage. Alternatively, stretchable fabric covers—which have attempted to remedy the problems of paper and plastic sleeves—fall short of uniformly protecting the vulnerable surfaces of a book.

For example, U.S. Pat. No. 5,004,514 issued to Pugliese et al. discloses a method of making a protective book covering, comprising a relatively long piece of plastic sheet material and a relatively short piece of plastic sheet material overlying the long piece, with longitudinal edges of the two sheets being heat scaled together, and the alternative option of applying a strip of adhesive to secure one of the longitudinal edges.

U.S. Pat. No. 5,013,068 issued to Maldonado discloses a protective envelope for a book comprising a stretchable sheet of compressible synthetic polymer fabric and a relatively thick layer of closed cell elastomeric compressible foam, lined on one side. The stretchable composite sheet may comprise foamed neoprene and stretchable nylon, the foam having a thickness between about 1/32 inch and 1/16 inch.

U.S. Pat. No. 5,029,900 issued to Axelrod discloses a wrap-around plastic cover for a bound book formed from a rectangular sheet having a center portion that abuts the book spine, with end portions of the sheet folded inwardly to enclose the front and rear covers of a book to be protected. The distal portions of the rectangular sheet thus form inwardly facing flaps to receive the front and rear covers of the book as a removable cover.

U.S. patents issued to Ostrowski (U.S. Pat. No. 5,056,663 and 5,092,630), Grande (U.S. Pat. No. 5,158,325) disclose adjustable protective book covers having similar features. The Ostrowski '663 patent discloses an adjustable cover having releasable hook and loop fasteners or adhesives which serve to secure a book within the cover. The Ostrowski '630 patent discloses a one-size-fits-all book cover which comprises sheet material with folded over top and bottom edges and sides with short hems. The side edges are folded over to form side pockets for insertion of the covers of a book therein.

U.S. Pat. No. 5,470,109 issued to Grande discloses an adjustable book cover made of spandex material which is cut in a unique diamond shaped pattern wherein two diagonal stitched seams converge to form the apex of a triangle for inserting front and back book cover portions. The cover also leaves exposed the top and bottom spine edge portions of the covered book which is cause for additional wear on the book. The “spine locking” feature does not work effectively. In order to stay above the spine area and not sag, the cover must be made to protrude significantly.

U.S. Pat. No. 5,158,325 issued to Landis et al. discloses an adjustable book cover similar to that taught by Grande, except that the insertable book cover forms pockets with a sinusoidal stitched seam at the lip of the insert portion of the cover. An integral, non-removable book marker appears to be superfluous and lack utility. Firstly, book pages may be readily segregated within the front and/or the back flap areas of the cloth book cover, without adversely affecting book closure, and without damage to the pages, covers, or spine of the book. Secondly, an attached book marker is cumbersome if not used, adding bulk to the inside of the book.

U.S. Pat. No. 5,209,624, Nocolaisen, discloses a method for interconnecting two sheets or plates for covering a book. The cover comprises an adhesive layer applied to a narrow zone extending along the adjacent ends of the plates. An adjoining portion of each plate is folded inwardly along a folding line, to define an acute angle with the longitudinal axis of the protective strip such that the free end portion of the protective strip extends beyond the edge of the sheet to form a gripping end.

U.S. Pat. No. 5,219,437 issued to Moore et al. discloses a fabric covered book cover comprising a front leaf and back leaf board, a spine having a plurality of integral ridges formed therein to promote foldability. The inside and outside surfaces of the cover are covered by woven nylon or other synthetic material.

U.S. Pat. No. 6,257,622 issued to Peker discloses a cloth book cover, preferably of spandex, the cover having end pockets to receive the front and back covers of a book in inserted relation therein. The top and bottom edges of the cover are stitched, the protruding portions of which tend to promote local wear. The formation of the end pockets requires undue extension of the cover material, when inserting a book within the cover in regular fashion, without reverse bending of the book spine.

None of the above inventions and patents, taken either singly or in combination, is seen to describe the instant invention as herein claimed.

### BRIEF SUMMARY OF THE INVENTION

The present invention provides a flexible empanelled book cover having pocket portions to receive the paperboard covers of a book in inserted relation therein. The cover pocket portions provide an access slot, parallel with the spine of the book, to facilitate insertion of the covers of a book within the pocket portions of the subject book cover.

The book cover consists of a unitary hexagonal sheet of pliable material with extended upper and lower edges, which are each bisected by a slot of predetermined depth, extending at right angles to the respective edge. The hexagonal blank contains four fold lines in the form of a laterally extended rectangle wherein the shorter side fold lines, in conjunction with adjoining side faces of the hexagon, define triangular flap portions of the aforesaid cover pockets.

The longer side fold lines, in conjunction with the respective upper and lower adjoining sections of the hexagon, define upper and lower flap portions which—when folded—abut the triangular side flap portions to which they are joined together. This attachment positions the horizontal edges of the blank, in mutually adjoined relation, providing two reciprocally aligned access apertures, by way of which the book is inserted into the protective cover. The bisecting slots do not intersect the fold lines. Rather, the vertices of the slots are positioned away from the respective aforesaid fold lines by a predetermined small amount, thereby creating a fold-over—when folding along the fold line is effected—which Holdovers engage the ends of the spine of the book in stabilizing relation.

The present invention further provides a method for manufacturing a book cover from a sheet of pliant material, including the steps of: cutting a laterally elongated, substantially symmetrical hexagon from a sheet of material; cutting a slot in each laterally elongated side—in substantially bisecting relation therewith—the slots extending at right angles to the respective elongated sides, and extending a predetermined distance into the hexagon; creating laterally extending fold lines, and end fold lines orthogonal thereto, to form a rectangle having the comers thereof coincident with the four shorter sides of the hexagon; folding inward the portions of the hexagon, located about the periphery of the rectangle, to bring edge portions of the hexagon into mutually adjoining relation; and securing the adjoining edge portions together, forming pockets to receive and conceal the exposed covers of a book in protected relation therewith.

In the foregoing method, the bisecting slots may be cut to extend adjacent to, but not to intersect, the laterally extending fold lines. The subsequent folding of upper and lower portions of the hexagon, about the laterally extending fold lines, creates a pair of central flaps. Such flaps engage the ends of the spine of a book, in stabilizing relation therewith, when inserted within the protective cover.

The present invention may be cut from “spandex” material, or other fabric materials composed of stretchable and elastic threads, such as nylon. In the case of spandex, the slot may have a width of one centimeter; in the case of nylon, the slot width is increased to as much as four centimeters, in order to avoid overstressing the nylon material. Additionally, the horizontal joints of the upper and lower flaps each comprise a row of stitching—including lock-stitching—applied at the innermost ends, to withstand the stresses applied when the cover is stretched during the insertion of a book within the cover.

The subject method also includes laying out and cutting a plurality of the aforementioned hexagonal blanks, in mutually nested relation, thus permitting the simultaneous cutting of the aforesaid bisecting slots, for two adjoined rows of hexagons, as a single slot. Further, adjacent hexagonal blanks, sharing adjoining peripheral edges, are also cut during the same procedure.

### BRIEF DESCRIPTION OF THE SEVERAL VIEWS OF THE DRAWINGS

Certain embodiments of the invention are described by way of illustration without limitation thereto, other than as set forth in the accompanying claims, reference being made to the accompanying drawings, wherein:

FIG. 1 is a front perspective view showing a book standing on its bottom edge, having the partly-open covers of the book concealed within a book cover in accordance with the present invention;

FIG. 2 is an interior plan view of the subject book cover in an open condition;

FIG. 3 is a developed plan view (to a different scale) of the panels of the FIG. 2 embodiment in an unfolded, unstitched condition; and,

FIG. 4 is a plan view of a portion of an endless sheet of pliant material showing the cut and fold lines for the mass production of the subject book covers.

### DETAILED DESCRIPTION OF THE INVENTION

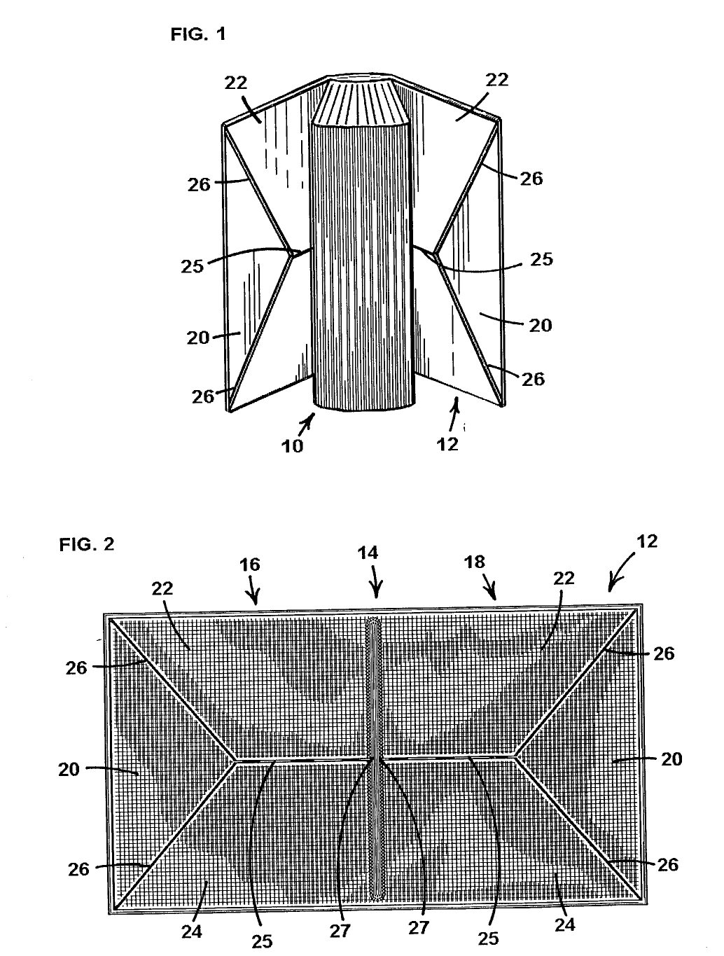

Referring to FIG. 1, a book 10 is shown, the covers of which are contained within and concealed by a book cover 12 constructed in accordance with the present invention. Referring to FIG. 2, the book cover 12 has a spine cover portion 14 laterally bounded by a (left) front cover portion 16 (for the book front cover), and a (right) rear cover portion 18 to receive the book back cover. The cover 12 consists of a number of panels in mutually folded, edge secured relation.

The cover seen in FIG. 2 shows triangular edge panel portions 20; top edge panels 22 and bottom edge panels 24 that form the interior of the book cover 12. The top edge panels 22 meet with the bottom edge panels 24, forming between them two pockets, 25 being lines of stitching that form the pockets by means of which the insertion of the covers of a book 10 into the book cover 12 is facilitated. The innermost junctures of the top panels 22 with bottom panels 24 are secured by way of locking stitches 27. The side edges of the panel portions 20, 22 and 24 where they adjoin are connected, preferably by rows of stitching 26. Alternative forms of connection such as taping and/or gluing, ultrasonic welding or R.F welding, or heat sealing are contemplated. The stitched seams may be made with interlocking stitching, which can be substantially concealed by turning the cover 12 inside out, whereby the stitching is contained inside the pocket portions of the book cover 12.

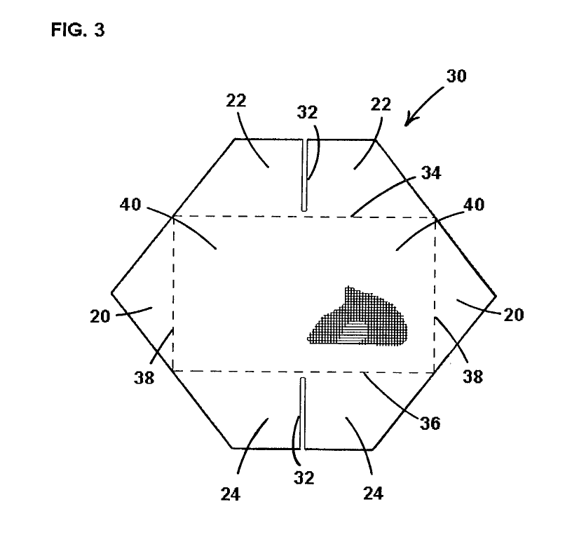

Turning to FIG. 3, the cover blank 30 is an unequal hexagon, having slots 32 of predetermined length in its top and bottom edges. Top fold line 34, and bottom fold line 36, together with side fold lines 38 form the bounds of the cover outer panels 40, which includes the intermediate spine area. The fold lines 34, 36 and 38 define one side of each of the panels 20, 22 and 24. It will be observed that the bottom or inner portion of each slot 32 does not reach the respective fold line 34, 36. This results in top and bottom turn-over portions of the cover 12 that overhang and engage the top and bottom portions of the book spine. This serves to stabilize the book within the cover 12.

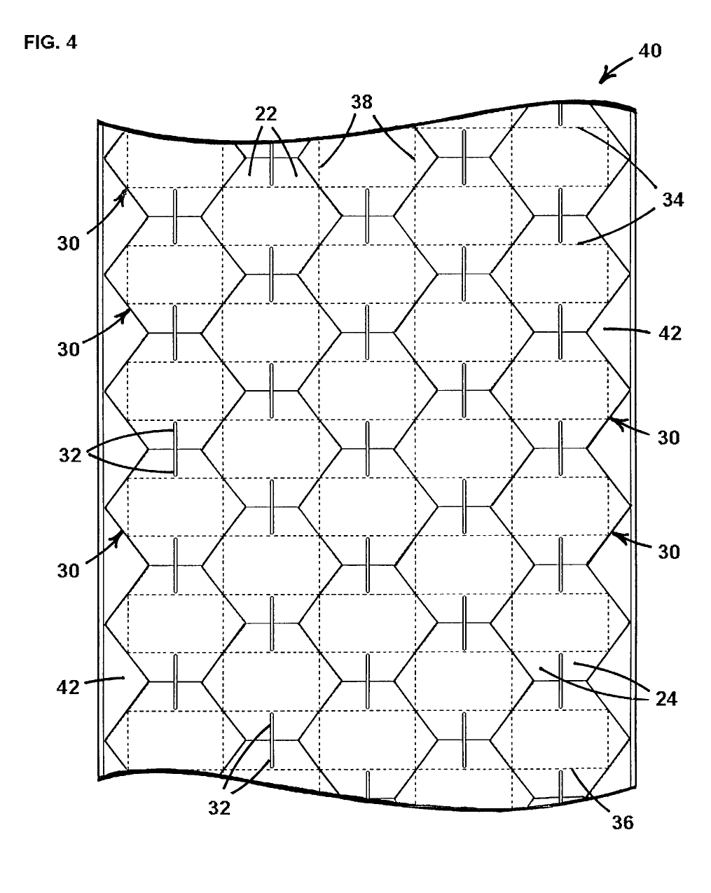

In FIG. 4 there is shown the fashion in which an endless supply (such as a roll) of material is marked and cut. The illustrated portion 40 shows twenty three complete cover blanks 30, with the fold lines shown dotted, to facilitate recognition of the respective blanks 30. It will be observed that a comparatively small amount of selvedge 42 is involved. The preferred pliant material is “spandex”. However, it will be understood that a group of plastics also lend themselves to such use, while the use of a loose-weave, highly flexible, substantially non-elastic fabric is contemplated.

1. A flexible book cover for insertion of a book in protected relation therein, said cover having outer panel portions for covering the front cover, back cover and spine portions of said book; said book cover having in-folded panel portions including triangular edge panels, in mutually edge-joined relation to form a pair of opposed pockets, each having an elongated aperture extending substantially parallel with said spine, in use to permit insertion of said front and back covers of said book in protected relation within the cover.

2. The flexible book cover as set forth in claim 1, wherein said cover consists of a unitary, laterally elongated hexagon of pliable material with extended upper and lower edges, each bisected by a slot of predetermined depth, extending at right angles to the respective edge.

3. The flexible book cover as set forth in claim 2, having upper and lower laterally extending fold lines, and side fold lines extending normal to said laterally extending fold lines and forming a laterally elongated rectangle therewith having the comers thereof substantially coincident with the sides of said hexagon, wherein said slots extend adjacent said laterally extending fold lines, in non-intersecting relation therewith, portions of said hexagon lying outside said rectangle being folded inwardly about said fold lines into mutually adjoining relation; mutually adjoining edge portions of said hexagon being secured together to form a pair of laterally opposed pockets, each having access thereto by way of said elongated aperture, to facilitate the insertion of the covers of a book therein.

4. The flexible book cover as set forth in claim 2, wherein said pliable material is elastic.

5. The flexible book cover as set forth in claim 3, wherein said mutually adjoining edge portions are secured together.

6. The flexible book cover as set forth in claim 5, wherein said edge portions are joined in mutual secured relation by fastening means selected from the group consisting of stitching, taping, gluing, ultrasonic welding, R.F welding and heat sealing.

7. The flexible book cover as set forth in claim 3, wherein said pliable material is spandex.

8. The flexible book cover as set forth in claim 3, wherein said pliable material is spandex, and said slot is about one centimeter in width.

9. The flexible book cover as set forth in claim 3, wherein said pliable material is fabric composed of stretchable and elastic threads.

10. The flexible book cover as set forth in claim 3, wherein said pliable material is fabric composed of stretchable and elastic threads, and said slot is about four centimeters in width.

11. A method for manufacturing a book cover from a sheet of pliant material, including the steps of: cutting a laterally elongated, substantially symmetrical hexagon from a material sheet; cutting a slot in each laterally elongated side in substantially bisecting relation therewith, the slots extending at right angles to the respective elongated sides and extending a predetermined distance into the hexagon; creating laterally extending fold lines and end fold lines orthogonal thereto to form a rectangle having the corners thereof coincident with the four shorter sides of the hexagon; folding inward the portions of the hexagon located externally of the rectangle to bring edge portions of the hexagon into mutually adjoining relation, and securing said adjoining edge portions together to form two pockets, in use to receive the covers of a book in concealed, protected relation within the pockets.

12. The method as set forth in claim 11, wherein said cutting step is selected from the group consisting of cutting by rule and rotary dies, rule and rotary dies with heating, and rule and rotary dies with ultrasonic energy.

13. The method as set forth in claim 11, said bisecting slots being cut to extend adjacent, in non-intersecting relation with said laterally extending fold lines, whereby upon folding upper and lower portions of said hexagon about the laterally extending fold lines, a pair of central flaps are created, which engage in stabilizing relation with the ends of the spine of a book when the book is inserted within the cover.

14. The method as set forth in claim 11, including laying out and cutting a plurality of said hexagonal blanks in adjoining rows having respective hexagons in mutually nested relation, and simultaneously cutting said bisecting slots of two adjoined hexagons as a single slot.

15. The method as set forth in claim 11, wherein said adjoining edge portions are stitched together, including applying lock stitching to the innermost adjoined edge portions.
